(19) United States
(12) Patent Application Publication
(10) Pub. No.: US 2004/0036993 A1
(43) Pub. Date: Feb. 26, 2004

(54) Transparent heat mirror for solar and heat gain and methods of making

(76) Inventor: Hla Ngwe Tin, Newport Beach, CA (US)

Correspondence Address: HLA NGWE TIN, 2281 GOLDEN CIRCLE, NEWPORT BEACH, CA, 92660, US

(21) Appl. No.: 10/439,383

(22) Filed: May 16, 2003

Related U.S. Application Data
(60) Provisional application No. 60/381,316, filed on May 17, 2002.
(60) Provisional application No. 60/452,333, filed on Mar. 6, 2003.

(51) Int. Cl. G02B 5/08; G02B 7/182

(52) U.S. Cl. 359/883

(57) ABSTRACT

Transparent Heat Mirror for solar and heat gain using conducting micro-grids or mesh on a transparent film or surface is disclosed. Methods of making such films and substrates (herein, termed films) include using magnetically aligned particles, and ultrasonically aligned conducting particles into conducting grids or mesh in an uncured matrix then curing the matrix to make transparent heat mirror film. The third method is by creating conducting areas with suspended particles on the micro-grid using inkjets to create optimum thickness on a transparent film. The fourth method is to deposit measured thickness and/or width of conducting or reflecting material by using micro inkjet printing techniques on a transparent or pre-selected film with predetermined transmission qualities. The sixth method of making such film is by embossing conducting or semiconducting microgrids on transparent metallized films or substrates. The seventh method is by nanometer scriptures using microfluidic systems with reflective and conducting particles. The eighth method of making such film is by electro-less plating techniques by sensitizing the area with light to be deposited with reflective or conducting particles. Still another method is to deposit a nano sheet constituting conducting polymer material on the surface of the film forming metal grids with holes. The micro-grids can also be formed with suspended transparent semi-conducting materials using inkjet or microfluidic techniques and then sintered to form the desired grids. Conducting materials includes conducting polymers such as, polyacetylene, polypyrrole etc., and transparent semi-conducting polymers, such as Sn doped Indium Oxide. Films with such properties are useful to achieve efficient conversion of solar energy to thermal energy. Transparent heat mirrors should transmit solar (with a wave length range of 0.4<λ<2.5 μm for air mass 2) and useful radiation but reflect the thermal radiation from the heated absorber (with range of 2.5<λ<100 μm for most applications) or area.

### CROSS REFERENCE(S) TO RELATED APPLICATIONS

The present application claims priority pursuant to 35 U.S.C. 119(e) to U.S. Provisional Application Ser. No. 60/381,316, filed May 17, 2002 and, U.S. Provisional Application Ser. No. 60/452,333, filed Mar. 6, 2003.

### DESCRIPTION

1. Field of the Invention

The invention is in the field of heat-mirrors and more particularly in the field of heat-mirrors having high reflectivity in the infrared spectrum, and high transmission in the visible spectrum, using a transparent film that has a micro-grid pattern, The film is applied to solar collectors for efficient solar energy collection, and to enhance radiation insulation resulting in heat gain inside the collector or in the case of a building area, the film is placed on the window through which the radiation enters.

2. Background of the Invention

Transparent heat-mirrors are useful in the collection and trapping of solar energy, and in other applications where it is desired or necessary to have high infrared reflectivity with high solar transmission. Fan, et al, in the U.S. Pat. Nos. 4,337,990, 4,822,120 and 4,721,349 taught a method for making transparent heat mirror comprising composite films. These films include a discrete and continuous layer of metallic silver sandwiched between a transparent, outer, protective, anti-reflection layer and a transparent, phase-matching layer. This combination of layers is chosen to provide high solar transmission with minimum loss of thermal radiation.

Breman et al. in the U.S. Pat. No. 4,663,495 describes a method for making transparent photovoltiac module whereby a transparent conducting metal is used to reflect back the solar energy spectrum that is not radiated back from an absorber towards the solar cells hence enhancing the cell efficiency.

Lyman in U.S. Pat. Nos. 5,239,406, 5,523,877, 5,680,245, 5,864,419,5,986,797, 6,122,093, 6,304,363 and 6,350,397 disclosed methods for making vehicular glazings that reduces ultravoilet and reflect near infrared reflecting glazings for automotive applications.

Application for making incandescent lamp is provided in U.S. Pat. No. 4,346,324 by Yoldas in his energy-conserving incandescent lamp. The incandescent lamp has the envelope which is provided on the interior surface with a very efficient and economically applied heat mirror which is highly transmissive for visible radiations and highly reflective for infrared radiations, thereby enhancing the conversion of electric energy to visible energy. The heat-mirror coating comprises a two layer Ag/TiO.sub.2 or a three layer TiO.sub.2/Ag/TiO.sub.2 coating of predetermined thickness. The three layer coating is formed by first applying to the envelope interior surface a thin layer of clear aliphatic alcohol solution having contained therein partially hydrolyzed metallic alkoxide which substantially comprises titanium alkoxide, and which solution contains at most only a limited amount of selected mineral acid. The applied clear solution layer is heat treated to convert same to a thin continuous layer substantially comprising titania. A thin silver layer is applied over the first applied titania coating, preferably by vacuum metallizing, and a second thin layer of solution containing the partially hydrolyzed metallic alkoxide which substantially comprises titanium alkoxide is applied over the silver layer. Thereafter the applied second layer is heat treated to convert same to titania, with the heat treating temperatures and atmospheres controlled so as not to affect the applied silver layer. The two layer coating is applied by omitting the first TiO.sub.2 coating step and references therein.

Transparent Heat Mirror Prior Art for solar application.

Heat-mirrors that reflect radiation in the infrared spectrum while transmitting radiation in the visible spectrum have important applications as transparent thermal insulators for furnaces, windows in buildings, and solar-energy collection. In the field of solar energy, for example, it is desirable to collect sunlight efficiently and to convert it into heat energy. Traditional strategy for optimizing thermal energy collection with a flat-plate collector has been concentrated on the absorber wherein the sun's radiant energy is converted into heat. If the absorber is a black body, it converts all of the incident radiation into heat, but it also converts the heat to infrared radiation that is reradiated back into space. Usual strategy is to design a material that has high absorptivity for radiation from the sun, but that has low emissivity for infrared radiation. For solar energy farms to collect solar energy for thermal to electrical power conversion, this requires a material that has a low emissivity for infrared radiation from a body at about 800.degree. K. Moreover, the absorber material possessing these properties must be stable at such temperatures for long periods of time, must withstand thermal variations from cold winter nights to 800.degree. K during the day; and must also be cheap to manufacture and to maintain in the field. The probability of success with this strategy alone appears minimal.

An alternate strategy is to introduce a heat-mirror that is separated from the heat absorber and will therefore be much cooler. Heat-mirrors designed for this purpose have been fabricated from tin-doped indium oxide and antimony-doped tin oxide. See Groth, R. and Kauer, E., Philips Tech. Rev., 26, 105 (1965); Groth, R., Phys. Stat. Solid, 14, 69 (1966); Fraser, D. B. and Cook, H. D., J. Electrochem. Soc., 119, 1368 (1972); Vossen, J. L. and Poliniak, E. S., Thin Solid Films, 13, 281 (1972); Mehta, R. R. and Vogel, S. F., J. Electrochem. Soc., 119, 752 (1972); and Vossen, J. L., RCA Review, 32, 289 (1971). Although these materials are stable in air up to 400°-500° C. and can have visible transmissions as high as 80-90% on Pyrex glass, their infrared reflectivities at around 10 micrometers (for room temperature radiation) are only between about 80-90%, which are much lower than desirable.

Kirchoff's Law states that the sum of transmission (Tr), reflectivity (R) and absorptivity (A) for a given wavelength must be equal to one, or Tr+R+A=1.0. For transparent heat-mirrors, solar transmission must be high, and hence the reflectivity and absorptivity must be low. In the infrared, however, the heat-mirror must have high reflectivity and so transmission and absorptivity in the infrared must be low. Using Kirchoff's Law, and assuming that transmission in the infrared is minimal, it can be shown that thermal radiation losses are directly proportional to (1-R), meaning that it is important to have an infrared reflectivity as close to 100% as possible while maintaining the solar transmission as high as possible.

Other heat-mirrors are also known. See Holland, L. and Siddall, G., British Journal of Applied Physics, 9, 359 (1958). These authors tested various metal oxide films on glass, gold films on glass, and gold films sandwiched between either bismuth oxide or silicon monoxide layers. They found that the optimum performance was obtained with multilayer composite having a 130 A gold layer sandwiched between two 450 A bismuth oxide coatings. Nevertheless, the transmittance of this composite was found to be only 73% for green light and the reflectance was only 74% in the near infrared region, values which are not satisfactory for solar energy collection and for many other applications where higher infrared reflectivity coupled with higher transmissions in the visible are required.

Horwitz in Optics Communications, Vol.11, Number 2, June 1974 mentioned a new waveguide methods of providing a selective surface for solar energy applications described. Some measurements of a vacuum-deposited mesh are given, and elementary theory indicates that ratio of solar absorptance to thermal emittance of 30:1 should be possible at temperatures of about 200 C.

Fan, et. al. in applied Physics Letters, Vol. 28, No. 8, 15 April 1976 published, “Thin-film conducting micro-grids as transparent mirrors.” A transparent mirror for solar energy applications was fabricated on a small scale by chemically etching a Sn-doped In₂O₃ film to form a transparent conducting micro-grid. For square openings 2.5 μm on a side, separated by lines 0.6 μm wide, the solar transmission increases from 0.8 from the original continuous film to 0.9 for the micro-grid. Although 65% of the area of the film is removed by etching, the infrared reflectivity decreases by only 9%, from 0.91 to 0.83. A smaller decrease in the infrared reflectivity may be possible if the materials with higher optical conductivity are used.

Ekouhoh et. al. in their theoretical paper, “On the use of grating or mesh selective filters to increase the efficiency of flat plate solar collectors”, showed that the grating selective filter is not adequate but that the mesh could be a suitable filter for increasing the efficiency of low to medium temperature of flat plate collectors. In their analysis, the optimal filter was found to be a structure having a period of 1μ and thickness or strip width of 0.05μ. This filter responds to visible and IR in the 0.4μ to 0.8μ and 4μ to 40μ respectively with transmission of >91% and reflection of <38% to <99% for 4μ and 40μ radiations. However, they mentioned that because of the size of the mesh involved, it is not practical with the then present technologies to manufacture such filters.

During 1980's this inventor was involved with holographic glazings while he was conducting research for the Department of Energy as the Project Manager at National Technical Systems, Inc. The work was carried out in conjunction with Southern California Gas, Co. In addition to what was reported in the above three references, the manufacturing process for micro patterns using holographic techniques were not adequate or are too costly to make these filters. However, later at General Optics Technologies, Inc at his own company in 1986, he was able to use the holographic manufacturing techniques to injection mold holograms into video cassettes front pieces by using a pin with a metal (nickel) shims on it, thus leading him to believe that meshes the size of ¼ of the wavelength of 0.4μ is possible to achieve on plastic materials on a manufacturing scale using injection molding or an equivalent, i.e. to stamp or mold micro scriptures in soft plastic. The equivalent would be to cool a soft glass or plastic with the mold patterns or micro-grids on it. Indeed similar processses have been found to work recently in soft lithography using soft molds and plastic materials for nanosize patterns. Two types of soft lithography are described in Scientific American Special Issue, Nanotech, the Science of the Small Gets down to Business. Sci.Am.September Issue, 2001, pp-41-44. (The two methods are called microcontact printing and Micromolding in capillaries, both of which can be applied to making the micro-grids. One can also construct micro-grids by using Dip-pen lithography as shown in the same article.)

At General Optics Technologies, Inc. this inventor also developed some techniques to deposit patterns of conducting metals electrolessly on plastic materials using light sensitizing methods for patterns. The deposited metal film is confined to the surface of a patterned organic film rather than the underlying substrates. It was tried for fabricating electroless plating for micro-grid structures. The underlying method is described in RCA Review June 1970, Pg. 439-443. See also, Selective Electroless Metal Deposition, Vol. 118, No.10, p.1697-1699.

Recently, nanoscience has created many configurations of nano size particles such as the bucky ball and nanowires, nanowalls and nanosheets. Since nanowires are wires made of a mesh of basic elements such as carbon atoms and the size of the holes are about the size we have mentioned above, that is around 1-2 micron in diameter or openings, they are a candidate for forming micro-grid transparent heat mirror if other conditions are satisfied. Other conditions such as heat resistant, combustion proof and easily applicable on a substrate and conductivity needs to be determined first. The same is true for nanosheets, and nanowalls.

We will now describe some of the methods and candidates that have been disclosed or have appeared in literature for making patterns to produce the desired effects of transparent heat mirrors but have not mentioned for micro-grid making process for making transparent heat mirrors.

A patent to Land, U.S. Pat. No. 1,955,923, concerns a light valve involving a dispersed mass of polarizing particles suspended in a light-transmitting medium, and applying to said particles an electrically controlled field of force, whereby the absorption of a light beam within the suspension may be altered. The polarizing bodies preferably employed are relatively small crystals. The crystals used should have some physical property, which is susceptible to the field of force to be applied. When a magnetic field is employed the crystals turn or rotate in the suspension so their axes tend to orient similarly.

In accordance with Goldberg et al U.S. Pat. No. 3,927,930, finely divided ferrite particles, e.g. having a particle size of about 0.02 micron in diameter, are suspended in a light-transmitting inert medium, preferably water, on a transparent support. A magnetic field is applied to the ferrite suspension whereupon the ferrite particles orient themselves in the medium to form elongated, line-shaped agglomerates, which polarize visible, light passing through the magnetized suspension. The medium may, for example, comprise a polymerizable monomer, which may be polymerized while in the magnetic field to freeze the ferrites in the oriented attitude in the solid polymeric medium. Photomicrographs were said to show regular line-shaped agglomerates of ferrite particles about 0.4 microns apart.

Ordering phenomena of particles, polystyrene spheres, in magnetic fluids have been studied; see A. T. Skjeltorp, J.Appl. Phys. 57 (1), pp. 3285-3290, 15 April 1985, and Physical Review Letters, 51 (25), pp. 2306-2309, Dec. 19, 1983. Particle configurations in magnetic fluids have been described by R. W. Chantrell et al, J. Phys. D:Appl. Phys. 13 (1980) L119-2.

A 3M Light Control Film has been described in a brochure 98-0439-4252-7 (125) RI XY, referencing Industrial Optics/3M, Building 223-4W, 3M Center, St. Paul, Minn. 55144-1000, 612/733-4403. The brochure illustrates a film with 0.030 inch (762 microns) thickness with light control louvers stated to be 0.0005 inch (12.6 microns) thick and 0.005 inches (126 microns) or 0.010 inches (252 microns) spacing. U.S. Pat. No. 4,082,433, assigned to Minnesota Mining and Manufacturing Company, states that internally louvered sheets can be made by skiving a continuous web from a cylindrical billet that has been prepared by compressing an assembly of alternate circular layers of clear polymeric material and black or other opaque or transparent colored layers. To improve the clarity of the product, clear films may be laminated or coated on each side of the skived web. U.S. Pat. No. Re. 27,617 assigned to Minnesota Mining and Manufacturing, further describes the manufacture of such film.

U.S. Pat. No. 3,707,416 has an object to produce louvered films having uniform angles of louvers from the vertical, and a process involving skiving from a skewed billet. U.S. Pat. Nos. 4,764,410 and 4,766,023 concern composite structures involving coating of louvered films, and cite a number of prior patents relating to louvered films and their applications. U.S. Pat. No. 4,772,096 concerns a light-shader intended to prevent reduction of contrast ratio of views in a display, generation of moires and devastations of images in the views. The light shader includes a light-shading film on a light-transmissive substrate plate. The light-shading film includes a plurality of opaque walls standing along its thickness and defining corresponding light-transmissive cells. Such opaque walls can be formed by opaquely dyeing a set photosensitive resin and transparent cells by eliminating and unset photosensitive resin by alkaline cleaner to form micro-openings. U.S. Pat. No. 4,772,097 concerns a light control sheet comprising transparent layers and reflection layers interposed between the walls of opaque louver elements. Preparation methods include slicing a material, which has lamination layers and photo etching.

In acousto-optic deflectors, this inventor in his disclosure, “Solar shading and day-lighting films and methods of making”, showed how aluminum reflecting particles can be aligned in a liquid medium with ultrasonic waves to produce periodic structures of reflecting surfaces that are used for reflecting light in a predetermined direction. By changing the standing waves in the medium, the direction and amount of light transmission can be monitored in real time. The sunlight also can be blocked, transmitted or directed to a desired area by having real time reflecting surfaces by tracking the sun. (A separate disclosure is being prepared to teach how “invisible or visible louver films” can be made and used for day-lighting applications and solar concentrators with conic section grids using this technique.) However, there was no mention of how the micro-grid patterns can be made using this technique. The aluminum reflecting particles can be “frozen” in the polymer matrix and can serve as micro-grids as shown later in this invention.

Suspended particles have been used in window films where the windows are covered with films containing suspended particles which are turned off or on by applying a voltage to the film as a whole. In the above disclosure on window film by the inventor, the sunlight can also be blocked, transmitted or directed to a desired area by having real time reflecting surfaces by tracking the sun. (A separate disclosure is being prepared to teach how “invisible or visible louver films” can be made and used for day-lighting applications and solar concentrators using suspended particles.) Suspended particles method also incorporate microcapsules containing reflecting or materials with other optical properties which can be sensitized with light sources and later crushed to produce the desired louvers such as in the case of Mead Process for making color printing. Such microcapsules were used in Mead's printers both for color and black and white printing. Along the same line, the latest inventions have been in the area of E Ink or electronic ink which was invented by E Ink Corporation where reflecting or light absorbing (black) particles are used for displays and are given in U.S. Pat. No. 6,262,271, 6,249,271, 6,120,588 and the others mentioned in those patents. By choosing the design parameters of our patent application one can create micro-grids to meet the desired needs of optimizing transmission qualities from the film in use.

Recently, micro-inkjets are used to produce circuits on polymers using inorganic semiconductors. These inkjets with small orifices can also be used to produce periodic micro-grids in polymer films for window film application as described in the invention. Commercial Hewlett Packard large format printer adaptations will be ideal for this application.

### SUMMARY OF THE INVENTION

The present invention relates to Transparent Heat Mirror for Solar Flat Plate Collectors and for heat gain and other uses by fabricating conducting micro-grids or mesh on a transparent film. The invention also relates to methods of making micro-grids with the proper characteristics in or on a film by subjecting a viscous medium containing magnetic particles to a magnetic field, and subsequently curing the medium; and also using ultrasonic vibration to align reflecting or conducting particles. It also relates to the third method whereby a conducting micro-grid area is created with suspended particles or by creating the opaque area with suspended particles of optimum thickness on the matrix. The invention still relates to another method whereby a measured thickness and/or width of conducting or reflecting material is deposited on a transparent or pre-selected film with predetermined transmission qualities. It also relates to such films or matrixes made by embossing techniques on metallized films or substrates; and to films that are made by forming micro-grids with inkjet techniques. The seventh method is by nanometer scriptures using micro-fluidic systems with reflective particles. The eighth method of making such micro-grids is by electro-less plating techniques by sensitizing the micro-grid area with light to be deposited with reflective particles. Such films can also be made by using acousto-optics methods by using standing waves that are perpendicular or at an angle to each other in the liquid medium and “freezing” them as the liquid medium solidify. The next method of making such film is by using soft lithography whereby a soft template is used to form the microgids on top of films to have transparent heat mirror properties. Other methods also include stamping, roller embossing, injection molding and using femtosecond fast lasers to create different refractive index in the films and substrates. Films and substrates with such properties are useful to maximize the transmission of sunlight and to maximize the reflection of the reemitted infrared radiation from the collector surface. They are also useful in maintaining the filament temperature while operating at lower power usage for operation of an incandescent lamp.

The description and exemplification herein will mainly be concerned with collection of solar energy using transparent heat mirror with microgids as a means for optimizing heat energy collected. In further detail the films comprise conducting micro-grids with grid sizes related to that of the solar energy transmitted through the film and reflected upon reradiation from the pipe or collector. The grid openings (grid period) in this invention are generally about 1-2.5μ and the strip width is about 0.1-0.6μ. Such kind of film will transmit over 91% of solar radiation between 0.4μ to 0.8μ and reflect 38% to 99% of the solar radiation between 4μ to 40μ for the 1 and 0.1μ grid sizes and for the 2.5μ and 0.6μ micro-grids with transparent grids, the transmission can achieve as high as 90% with the infra red reflection of 83%. The emmisivity which is the ratio of absorption to transmission can therefore, be very high. A representative diagram of solar collector is shown in FIG. 1, and in FIG. 2 and FIG. 3, the micro-grids are shown for the two cases above. The micro-grids are fabricated from thin films of Sn-doped In ₂ O₃ of small particles of material, generally in the very small or, nanometer range and preferably with transparent conducting materials for maximum transmission. They are about less than 0.35μ thick.

The micro-grids can also be composed of agglomerates of particles that are not transparent in which case the transmission of solar energy will be reduced due to the shadowing of the solar insolation. Magnetic particles, such as ferrites are particularly suitable for such a case, and also ferromagnetic materials are used for alignment by magnetic forces.

In the same manner the micro-grids can be made by the other methods described in the Description area of the invention all of which has the unique property that they have high emissivity. Many of the methods for making the transparent heat mirrors other than micro-grids are described by prior art. The finely divided ferrite particles that are used to make louvers are also described by Goldberg in U.S. Pat. No. 3,927,930 and can be applied to making micro-grids for transparent heat mirrors when the two sets of parallel louvers are crossed.

In addition to the above methods described by others on making the louvers which can be applied for making micro-grids, we have described here different methods used to make the micro-grids in our invention. The following summarizes the different methods used in this invention other than what is described above.

In acousto-optic method, conducting particles are aligned in a liquid medium with two ultrasonic waves perpendicular to each other to produce micro-grid structures that are used for transparent heat mirrors for solar energy collectors. By changing the standing waves in the medium, the micro-grids can also be formed on the surface of the liquid medium. The aluminum reflecting or conducting particles can be “frozen” in the polymer matrix and can serve as micro-grids. The inventor has described this method in his patent application for microlouvers for, “Solar shading and day-lighting films and method of making”. Micro-grids are essentially two louvers that are crossed at an angle and in our case we have described a micro-grid with a square structure. This structure can be obtained by having two acoustic generators perpendicular to each other coupled to a fluid that is “frozen in” later with the conducting particles.

Suspended particles have been used in window films where the windows are covered with films containing suspended particles which are turned off or on by applying a voltage to the film as a whole. By choosing the contents of the suspended particles of this application one can create reflecting or conducting micro-grids to meet the desired needs of transparent heat mirror for solar collectors.

Recently, micro-inkjets are used to produce circuits on polymers using inorganic semiconductors. These inkjets with small orifices can also be used to produce micro-grid structures with nanosize conducting materials on polymer films or transparent substrates for transparent heat mirror film application as described in the invention. The inkjet printers can be programmed to make these scriptures. Normally, the high-temperature processing requirements and isolubility of common inorganic conductors and semiconductors are problematic. However, both these problems disappear in the nanometer size regime. Nanoparticles are readily soluble in appropriate solvents, and their size dependent melting point depression is remarkable. Semiconductor nanoparticles have been reported to melt at greater than 100 degrees Centigrade below their bulk melting points. These size dependent properties are the result of the nanoparticles having properties somewhere between those of an atomic species and a bulk crystal. These size-dependent properties enable the use of nanocrystal solutions as precursors to bulk thin film formation in the fabrication of the micro-grids.

The invention also involves methods of affecting or controlling the transmission of light rays by permitting the light rays to strike a thin film containing micro-grids, particularly by filtering out some rays while permitting others to pass through the film depending upon whether the base films are heat or UV rejecting films. Accordingly the films will have the property of rejecting the specified heat/UV rays and will also have the shading property.

This invention also describes how the conducting micro-grids can be stamped or molded into soft plastic with microscriptures on them that meets the criteria, using the methods employed in the manufacturing of holograms by first making the metal mold. Metal shims can be produced from the mold and rolled on to the plastic sheets that are metallized or hot stamped on to transparent substrates. One can also use the equivalent by cooling a soft glass or plastic with a soft mold pattern or micro-grids on it that has the proper optical properties, such as, those of Sn-doped In₂ O₃ films. Indeed similar processses have been used recently in soft lithography using soft molds and plastic materials for nanosize patterns.

In this invention, electro deposition and electroless deposition methods are described where a metal mask is used and in the electroless case sensitizing with UV light to electrolessly deposit conducting metal on the sensitized area creating a micro-grid of the required dimensions.

An electro-less deposition techniques, comprise of,

i. sensitizing the substrate by depositing a layer of light-sensitive material such as Sn(II) species on the surface,

ii. photo-oxidation of the areas to be deposited with conducting material with UV light through a mask,

iii. activating the unexposed portion of the surface by immersion in a solution of metal chloride such as PdCl(2) to cover the unexposed portion with the metal, and

d) electrolessly plating the area with another metal. This type of process is often known as Photo Selective Metal Deposition method.

Micro-grids can also be formed with conducting nanowires that are thermally sinked to the substrate so energy of the solar insolation is dissipated to the collector. Nanosheets are natural grid patterns that can be deposited on transparent films by sensitizing the substrate with appropriate chemicals and photomasks that matches the microgrids pattern to make the micro-grids for solar energy collection.

The invention also discloses how micro-grid sciptures can be programmed on a computer to simulate the microstructure of transparent heat mirrors. For this case large format inkjet printers will be of utmost benefit since one can make large transparent mirrors in a very short period of time.

Conducting and semiconducting polymers can be applied to the transparent films or substrates in the form of micro-grids using several methods, including inkjetting, soft molding, soft stamping, hot stamping, roll embossing, and electroless plating methods. All of these methods except for inkjetting requires a lithographic mold be made or a photo mask used to aid the process.

### DESCRIPTION OF THE DRAWINGS

FIG. 1 is an illustration of the flat plate solar collector. The super structure (SS) consists of a stack of glass panes. The infrastructure (IS) is composed of blackened metal in the form of sheets, wafers, or planar arrangements of pipes. The micro-grid film is ideally place on top of the IS.

FIG. 2 is a description of a micro-grid structure or crossed parallel strip gratings or mesh. Each set of gratings are parallel to each other and are perpendicular to the other set. However, one can also make the micro-grid structures that are crossed at an angle or form honey comb structures. It is the size of the apertures that are important for transmission of the solar energy and the reflection of the reradiated infrared from the collector.

FIG. 3 shows one of the micro-grid structure fabricated from Sn-doped In₂O₃ film (transparent semiconductor) by vapor deposition. The width of the lines are 0.6 micron and the period of the structure is 2.5.

FIG. 4. Optical transmission and reflectivity of a Sn-doped In₂O₃ (transparent semiconductor) film on a glass before etching (solid lines) and after etching to form a conducting micro-grid enhaces the transmission of solar energy and just a slight decrease in the reflectivity of infrared from the reradiation using infinite conductivity at all frequencies in the calculation.

FIG. 5 This figure shows how acoustic transducers can be used to create grid patterns in fluids that can be “frozen in” with conducting or reflecting particles to create microgids for transparent heat mirrors. A standing wave pattern is created in a fluid containing small reflecting or conducting materials, with an acoustic device, to form rarified areas where reflecting materials reside; and these surfaces formed by the reflecting particles reflect the light incident upon it and divert the sunlight to the rear of the room. The standing waves are created by using a transducer against a liquid medium with reflecting particles. The frequency of the transducer and the liquid determines the size of the standing waves.

FIG. 6 is a diagram showing how micro-grid structure is formed by suspended particles on a transparent film. The suspended materials can be made out of transparent conducting materials such as shown in FIGS. 3 and 4. The patterns can be formed by using injet printers. Applying voltage to the pattern can also change the optical characteristics of the film.

FIG. 7 is a diagram showing the two soft lithography processes: Microcontact Printing and Micromolding in Capillaries. The steps are self explanatory.

FIG. 8 is a schematic diagram showing how electroless metal deposition is done by UV sensitization methods.

FIG. 9(a) shows how the conducting nanowires can be made laid down perpendicular to each other or at an angle to form micro-grids.

FIG. 9(b) shows how conducting naosheets on a transparent plastic sheet can be used as a transparent heat mirror with grid pattern, in this case the grid is a hexagonal structure.

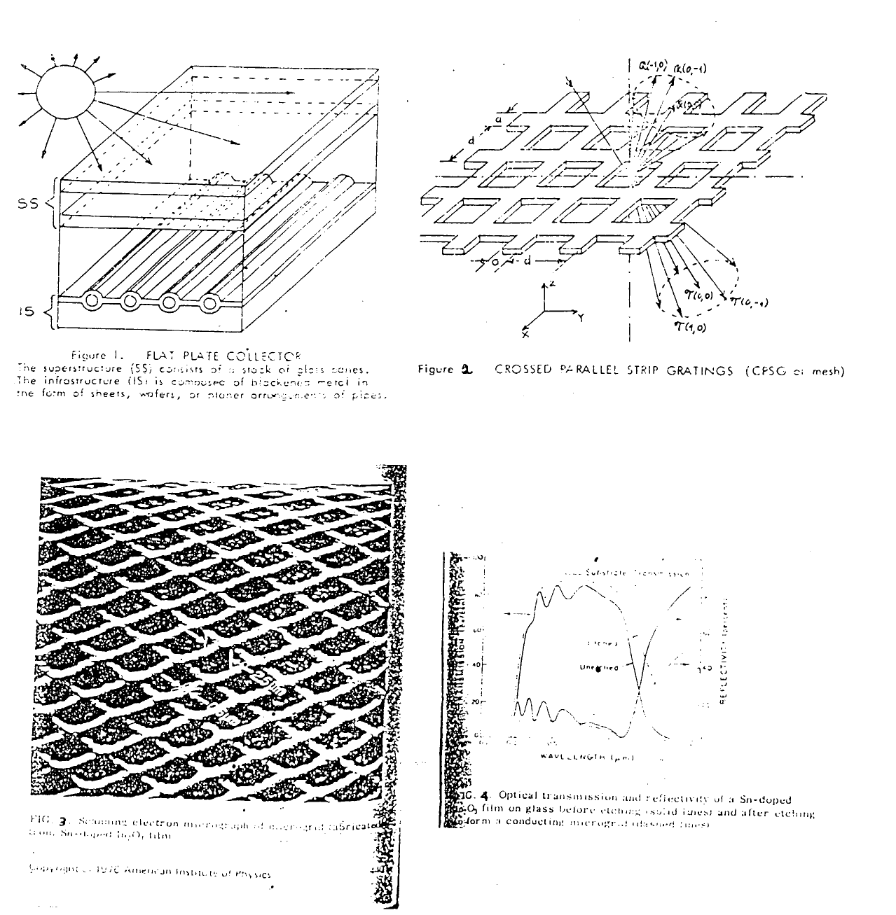

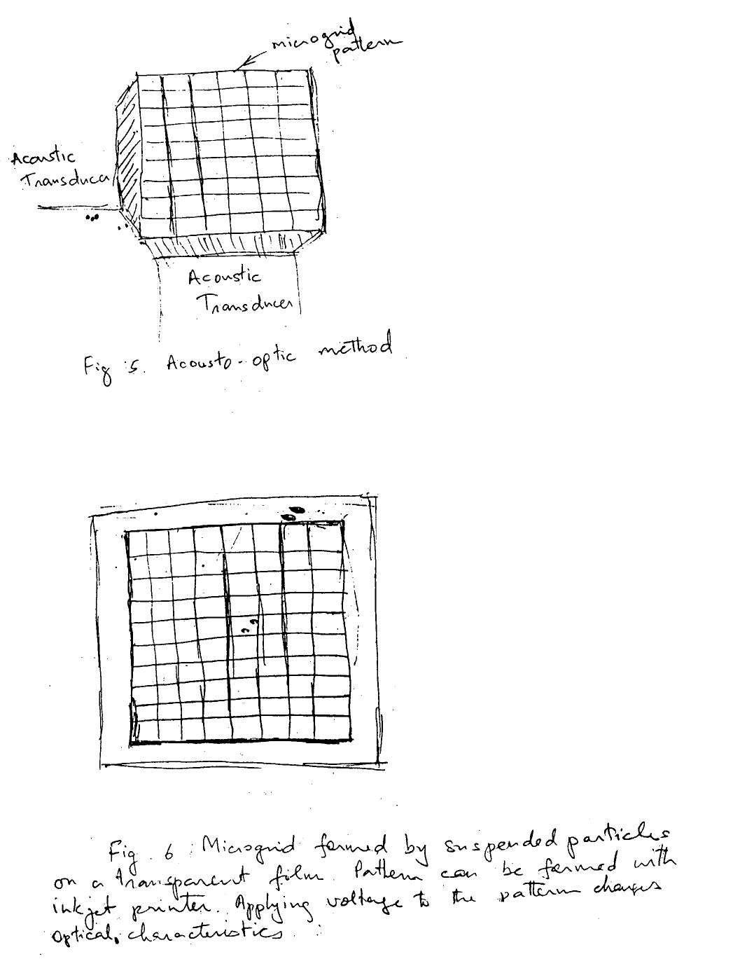

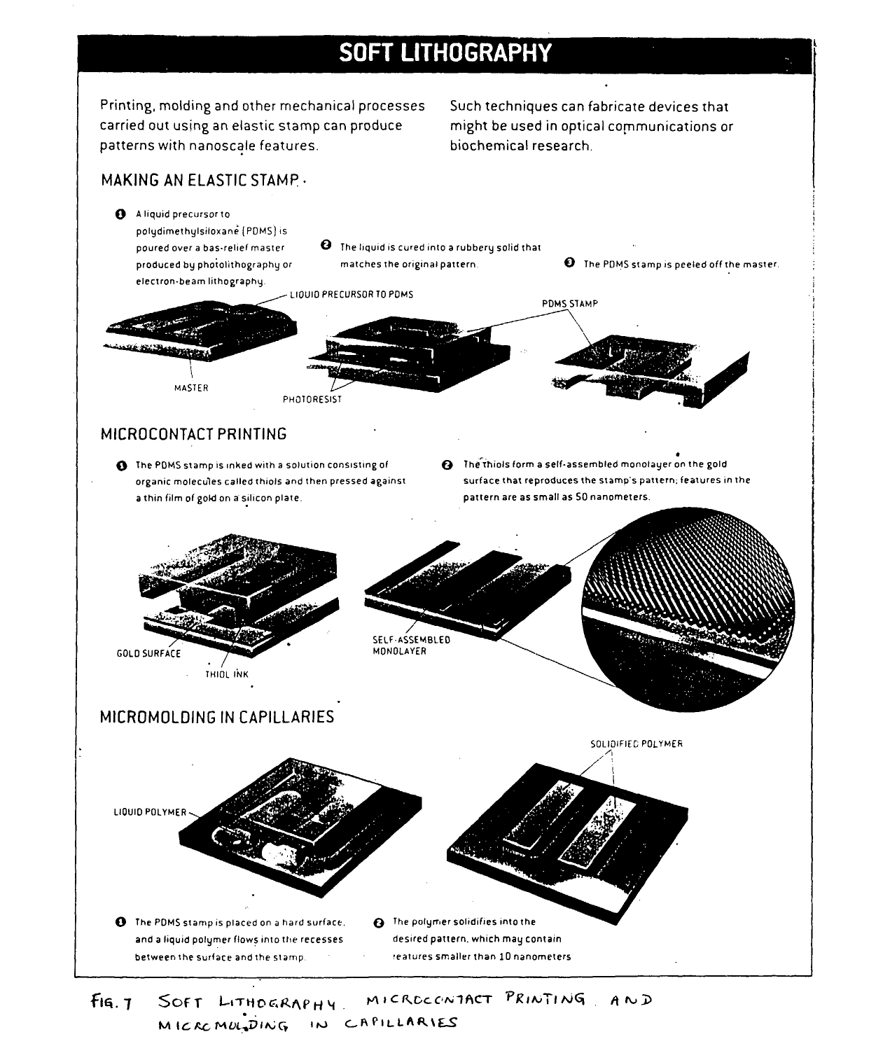

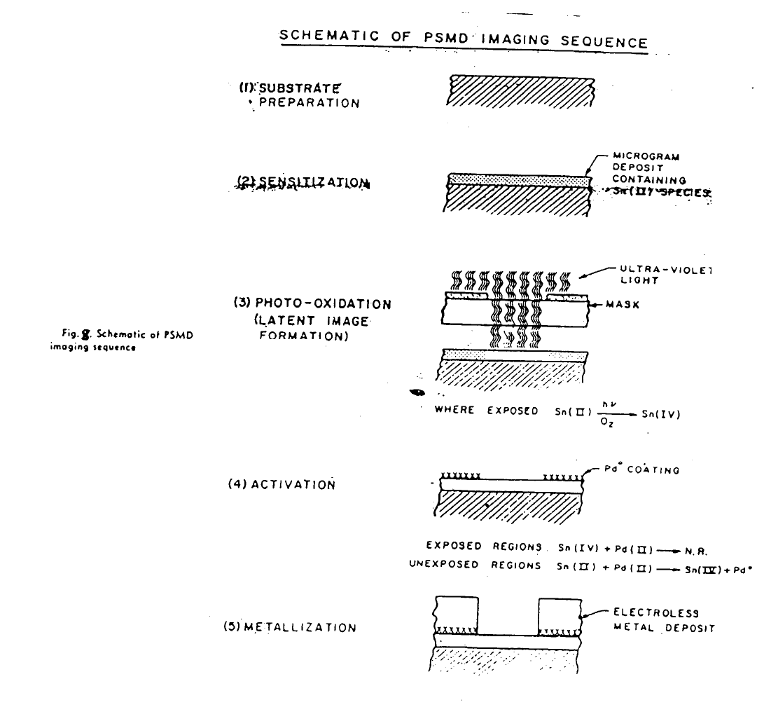

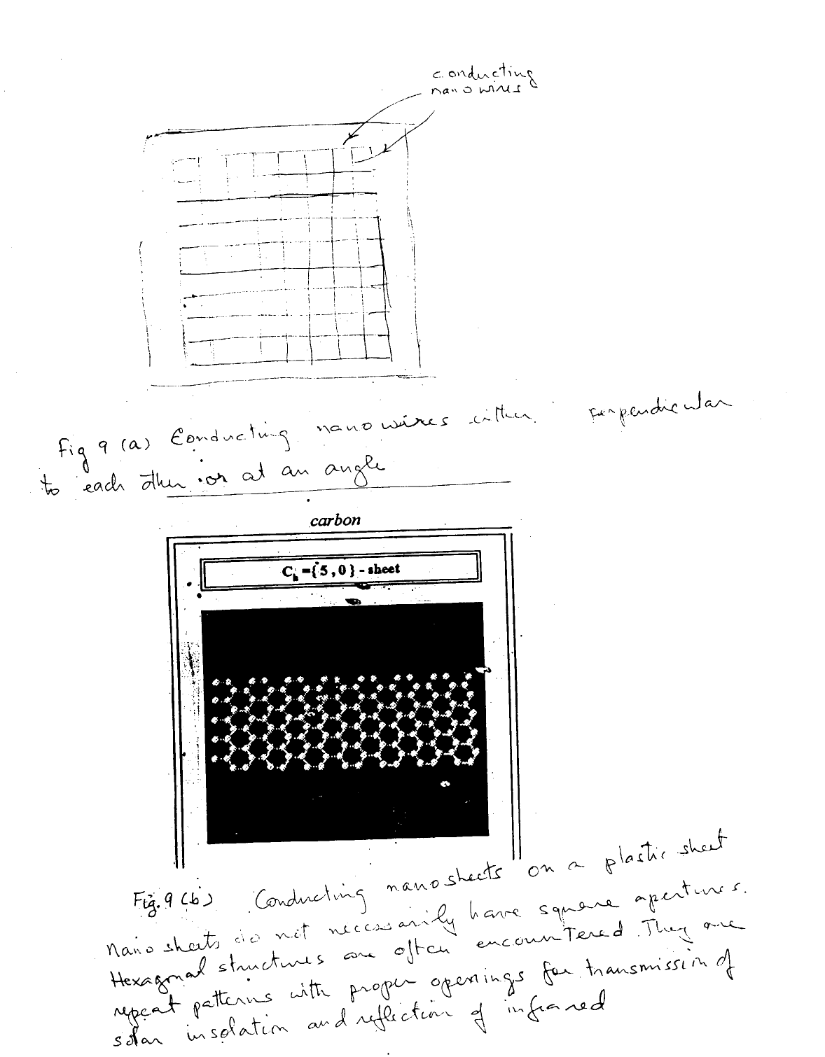

### DETAILED DESCRIPTION

The agglomerates in the films herein have appreciable thickness and, when of opaque or similar material, can block a high degree of light impinging thereon. In one preferred embodiment, the agglomerates are in the form of louvers, resembling venetian blinds, with the agglomerates being in the shape of walls of appreciable thickness, but generally relatively thin compared to their height. However the agglomerates can also be in the form of walls of lower height, such as walls of approximately square, circular or hexagonal cross section, and resembling rods or monofilament materials. The walls can also be aligned normal to the film's surface thereto.

Conventional coating and extrusion techniques can be employed in the preparation of viscous particle-containing matrixes for use in the present invention and conversion to stable light transmission materials. A viscous fluid medium is employed and converted to solid form or “frozen in” in some cases by a selected means, e.g. polymerization, crosslinking, solvent evaporation, etc. Polymerizable monomers, especially oligomers, which can be converted readily into stable, light-transmitting polymeric films, are particularly suitable. Various polymeric or pre-polymeric materials can be used, e.g. polyurethanes, acrylics, methacrylics, polyesters, e.g. glycol-phthalate esters, nylons, polyolefins, and various other thermoplastic and thermosetting resins, particularly organic polymer resins. Glasses and other film forming materials can be used, including sodium polysilicate and usual commercial glasses and special purpose glasses. Particles can be magnetically aligned if the Curie temperature (i.e. the temperature where spontaneous magnetization disappear) is above the melting point of the matrix. There are low melting glasses that can be used, e.g. B₂ O₃ and certain silicate glasses have melting points below the Curie temperatures of Fe (770.degree. C.) and Fe₃ O₄ (585.degree. C.). For melting points, see Silicate Sci., Eitel, II Glasses, Enamels, Slags, pp.66-67, FIG. A59 (546.683 EIS). The present invention can employ conventional coating, molding, extrusion, injection, and forming procedures, but involves incorporating small concentrations of alignable particles into the formable matrices, and aligning the particles and fixing the alignment.

In most cases, except for the case of acoustical method, we have employed nanosize particles to make use of the physical properties of small size particles to fabricate the micro-grid structures. In this way high temperature processes as well as solubility limitations disappear for the conducting materials that needs to be printed with inkjets or to be embossed with stampers or rollers and injection molding systems.

In preparing the present transparent heat mirror, it will be convenient for high volume operations to employ continuous procedures in which materials are transported through various stages for sequential operations, as on a moving belt for coating, alignment, and curing operations. In such procedures a coating can conveniently be applied to a pre-prepared, solid supporting film and subsequently cured as an adherent layer on such support to provide a composite film product. However it is also possible to prepare strippable coating materials, which can be formed into freestanding film materials, or to employ other means to obtain freestanding films or filaments. The coating procedures can involve such conventional methods as wire rod coating, air-knife coating, slot-orifice coating, knife-over-roll coating, reverse roll coating, and gravure and reverse direct gravure. See Roll Coating by R. T. Schorenberg, Modern Plastic Encyclopedia, 1984-1985, pp. 202-203, which is incorporated herein by reference.

It is a feature of the present invention that very thin films, i.e. of the order of 2 mils or less (approximately 50 microns or less) can be used to achieve desired solar transparent heat mirrors. The suitability and economy of such thin films will be an advantage in many applications. Also with such thin films as a coating on somewhat thicker supporting films, a still relatively thin film is provided for use. Films have many recognized uses in light transmission and related purposes, and films, characterized by being relatively thin in one dimension, e.g. thickness, but relatively great in another dimension, e.g. width, are an important form for use of the present invention. However the present invention can also involve other forms of sun light control materials, such as relatively thick blocks of material, or filaments of circular or other relatively symmetrical shapes. The films are often relatively flexible, but can also be prepared in rigid forms.

In various application it may be convenient to employ the sun light transparent heat mirrors of the present invention as an adherent layer or interlayer in other light control materials, e.g. in architectural glass or automobile windshields or windows.

1. A transparent heat mirror comprising:
a) a transparent surface or substrate,
b) radiation collection means having at least two parallel sets of linear conducting materials forming a micro-grid structure, with apertures of individual openings or grids approximately less than the size of an infrared wave length, and with a width of the linear conducting material in the sub-micron range, applied to the surface or substrate, and facing the radiation source,
c) a protective means comprising a transparent layer placed on top of the micro-grids,
d) and application means for applying the substrate to a heat collection area with a transparent optical adhesive, whereby, efficient collection and insulation of solar or heat gain in the area is achieved, resulting in maximum temperature for the heat collection area.

2. A transparent heat mirror of claim 1, wherein transparent surface is made of plastic film or transparent substrates such as glass or plastic, and the micro-grid is made of high conductivity material that is highly transparent to solar and other electromagnetic radiation whereby, high transmission of the radiations is achieved and the reradiated infrared from the collection area is reflected back to the collection area by the micro-grid for maximum collection temperature.

3. A transparent heat mirror of claim 2, wherein the size of the micro-grid is about 1-2.5 μm on a side and a width of the line about 0.24-0.6 μm and the parallel set of lines forming the micro-grid are at an angle to each other.

4. A transparent heat mirror of claim 3, wherein said heat mirror has micro-grids made with a measured thickness of approximately 0.35μ of conducting material on a film having predetermined optical qualities.

5. A method of making a transparent heat mirror of claim 3 and 4, wherein said micro-grids are formed by aligning conducting materials at essentially perpendicular to each other on the surface of said film.

6. A method of making a transparent heat mirror of claim 3 and 4, wherein said micro-grids are formed by depositing single or multiple layer conducting nanowires at essentially perpendicular to each other on the surface of said film using vacuum deposition techniques.

7. A method of making a transparent heat mirror of claim 3 and 4, wherein said micro-grids are made by forming conducting nanosheets with openings on the properly prepared or sensitized surface of said film or absorber.

8. A method of making a transparent heat mirror of claim 3 and 4, wherein said micro-grids are made by forming conducting nanowalls by microwave-plasma-enhanced chemical vapour deposition technique.

9. A method of making a transparent heat mirror of claim 5, wherein said microgrids are made by aligning agglomerates of particles of a magnetically-alignable material using magnets.

10. A method of making a transparent heat mirror of claim 3 and 4, wherein a method of fabricating the micro-grids, comprise the steps of:
a) suspending agglomerates of conducting particles in a curable medium,
b) forming two standing waves at an angle using ultrasonic transducers,
c) curing the medium in which the conducting particles have settled
d) overlaying with an optically clear protective layer and
e) having an optical adhesive backing for the film or substrate.

11 A method of making a transparent heat mirror of claim 3 and 4, wherein a method of fabricating the micro-grids, comprise the steps of:
a) depositing suspended transparent conducting particles on the film by ink jet printing techniques, and
b) evaporating the ink, whereby the transparent conducting particles form the micro-grid,
c) overlaying with an optically clear protective layer and
d) having an optical adhesive adhesive backing on the film or substrate.

12 A method of making a transparent heat mirror of claim 3 and 4, wherein a method of fabricating the micro-grids, comprise the steps of:
a) impregnating conducting particles in microspheres and
b) suspending said microspheres in organic or inorganic fluids
c) using the suspension as ink in the ink jet printers, and then
d) letting the ink suspension fluids to evaporate.

13 A method of making a transparent heat mirror of claim 11, wherein said film has micro-grids made by impregnating suspended particles with reflecting materials, such as titanium dioxide to produce reflecting regions.

14 A method of making a transparent heat mirror of claim 3 and 4, wherein said film with micro-grids are created by embossing conducting materials on the substrate that has predetermined optical characteristics with a molded roller, the roller being made with metal shims from micro-grid molds

15 A method of making a transparent heat mirror of claim 3 and 4, wherein a method of fabricating the micro-grids, comprise the steps of
a) chosing a film or substrate with predetermined optical characteristics,
b) making a mold of the micro-grid using photolithographic methods on a metal shim,
c) overlaying the film or substrate with another film, metallized with transparent conductor or a semiconductor with proper band gap, and having an optical adhesive adjacent to the film or substrate,
e) embossing the conducting materials onto the film with hot stampers using the metal shim made by photolithographic methods, whereby the micro-grid pattern is transferred to the substrate or film.

16 A method of making a transparent heat mirror of claim3 and 4, wherein said films with micro-grids are created using photolithographic techniques comprising,
a) depositing a layer of conducting material on the transparent film by using such deposition techniques as electrodeposition, and rf sputtering using semiconducting materials such as Tin doped Indium Oxide and other transparent semiconductors,
b) coating with a photoresist layer
c) exposing with a micro-grid pattern mask to open the holes, and
d) chemically etching away the exposed conducting materials in the hole areas.

17 A method of making a transparent heat mirror of claim 3 an 4, wherein said films with micro-grids are created by electro-less deposition techniques, comprising,
a) sensitizing the substrate by depositing a layer of light-sensitive material such as Sn(II) species on the surface,
b) photo-oxidation of the areas to be deposited with conducting material with UV light through a mask,
c) activating the unexposed portion of the surface by immersion in a solution of metal chloride such as PdCl(2) to cover the unexposed portion with the metal, and
d) electrolessly plating the surface in an appropriate electroless plating bath.

18. A method of making a transparent heat mirror of claim 3 and 4, wherein a method of creating the microgrids comprises of
a) choosing a film with predetermined optical characteristics, such as those with infrared and ultra-violet rejection qualities
b) using an ink that is made with nano particles, or suspended nano particles in a solvent, organic or inorganic fluids and
c) printing the micro-grid pattern with an inkjet on the film to form the micro-grid.

19. A method of making a transparent heat mirror of claim 3 and 4, wherein a method of creating the microgrid comprises the steps of:
a) applying a layer of monomers that can be polymerized into conducting polymers onto the transparent film or substrate,
b) polymerizing monomers of conducting polymers, such as polyacetelyne, polypyrrole, etc., using photomasks and light sources,
d) removing the monomers so as to form a conducting micro-grid structure on the transparent film or substrate.

20. A method of making a transparent heat mirror of claim 3 and 4, wherein the micro-grid is made by using the soft lithography methods using nanoparticles as ink.

21. A method of making a transparent heat mirror of claim 20, wherein the micro-grid is made by microcontact printing techniques comprising the steps of:
a) choosing a transparent film or substrate with a predetermined optical characteristics,
b) making a photolithographic etch of the micro-grid pattern on a photoresist,
c) heating a liquid polymer, curing and peeling off with the micro-grid pattern, forming a negative mold of the photoresist pattern,
e) inking the polymer mold with conducting materials, and
e) forming a micro-grid structure on the transparent film or substrate.

22. A method of making a transparent heat mirror of claim 20, wherein the micro-grid is made by using the soft lithography methods comprising the steps of:
a) making a negative injection mold with the micro-grid pattern by etching photoresist on the mold or the inset,
b) injecting conducting material solutions made up of nanosize particle into the injection mold, and
c) forming micro-grid pattern on the transparent substrates and
d) sintering the pattern so as to form bulk material from the nanocrystalline particles.

23. A method of making a transparent heat mirror of claim 12, wherein the suspended particles are embedded in microcapsules that can be sensitized by light and can be crushed by mechanical pressure to produce the desired micro-grid structure using a micro-grid mold.

24 A method of making a transparent heat mirror of claim 3 and 4, wherein the micro-grid structure is made by a method comprising,
a) chosing a substrate with a predetermined optical characteristics,
b) choosing the proper femtosecond laser and power to match the substrate for scribing inside the substrate and
c) scribing the microgrid structure inside the substrate material to form the transparent heat mirror.

25. A method of making a transparent heat mirror of claim 3 and 4, wherein the micro-grid structure is made by a method comprising:
a) Choosing a substrate with a predetermined optical characteristics,
b) forming a microfluidic mold for the micro-grid structure on the substrate,
c) injecting an appropriate amount of a solution containing a reflective or conducting material into the micro-grid mold
d) drying the fluid to leave behind the conducting material in the mold,
e) placing a protective layer on top of the microgrid,
whereby a transparent heat mirror is formed.
